(19) United States
(12) Patent Application Publication
(10) Pub. No.: US 2004/0179449 A1
(43) Pub. Date: Sep. 16, 2004

(54) Method of playing copy-controlled audio discs in PC-based optical disc drives

(75) Inventor: Thomas O. McGoldrick, Laguna Hills, CA (US)

Correspondence Address: Mr. Eric S. Chen, PILLSBURY WINTHROP LLP, Suite 2800, 725 South Figueroa Street, Los Angeles, CA, 90017-5406, US

(73) Assignee: Toshiba America Information Systems, Inc., Irvine, CA (US)

(21) Appl. No.: 10/387,971

(22) Filed: Mar. 13, 2003

(51) Int. Cl. G11B 7/00

(52) U.S. Cl. 369/53.22; 369/53.37

(57) ABSTRACT

A method of playing copy-controlled compact discs (CCCDs) in PC-based optical disc drives includes forcibly recognizing at least one track in a first session of the optical disc as an audio track. At least one track in the first session is read to playback as audio.

### BACKGROUND OF THE INVENTION

1. Field of the Invention

The present invention generally relates to optical disc drives. More particularly, the present invention relates to playing copy-controlled audio discs (e.g., compact discs) in PC-based optical disc drives.

2. Discussion of the Related Art

Optical disc drives, e.g., CD-ROM drives and DVD-ROM drives, designed for use in the PC environment, have problems playing back copy-controlled compact discs (CCCDs). These CCCDs, e.g., Sony's key2audio™, Sunncomm's MediaCloq™, and Cactus Data Shield (CDS-100, CDS-200, and CDS-300), utilize various methods to keep PC-based optical disc drives from playing back audio data, or transmitting audio data digitally through an interface (e.g., CD “ripping”) so as to prevent these PC-based optical disc drives from accessing these CDs. Because these copy-controlled discs are often labeled as being not playable in PCs, they generally do not present any issues with PC optical disc drives since the consumer is forewarned not to play these CDs in them.

New applications for PC-based optical disc drives, and in particular, DVD-ROM drives, such as those being incorporated into home entertainment systems, for example, are becoming more popular and practical for home entertainment system manufacturers. These home entertainment systems incorporate a PC-based DVD-ROM drive, for example, as the media player for playing DVD movies and audio CDs with a single optical disc drive. Accordingly, the end user has an expectation that audio CDs, including copy-controlled CDs, will work with these optical disc drives included with home entertainment systems, just like in a conventional dedicated CD player, even though the home entertainment system actually incorporates a PC-based DVD-ROM drive.

### BRIEF DESCRIPTION OF THE DRAWINGS

FIG. 1 illustrates an optical disc drive according to an embodiment of the present invention;

FIG. 2 illustrates a flow chart diagram of playing a copy-controlled audio disc in a PC-based optical disc drive according to an embodiment of the present invention;

FIG. 3 illustrates a flow chart diagram of playing a copy-controlled audio disc in a PC-based optical disc drive according to an embodiment of the present invention; and

FIG. 4 illustrates a flow chart diagram of playing a copy-controlled audio disc in a PC-based optical disc drive according to an embodiment of the present invention.

### DETAILED DESCRIPTION

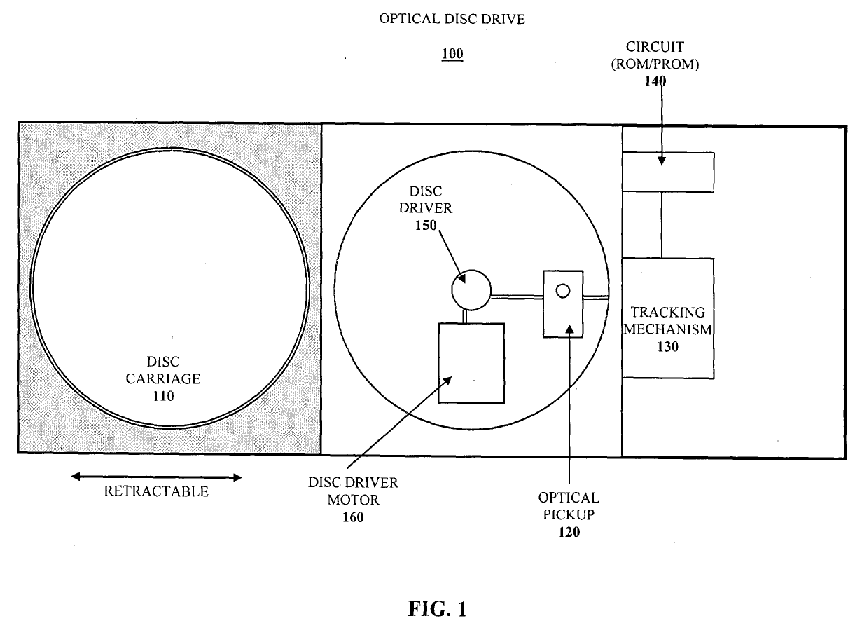

FIG. 1 illustrates an optical disc drive according to an embodiment of the present invention. The optical disc drive 100 may be a CD-ROM drive, a DVD-ROM drive, or any suitable optical disc drive adapted to read an optical disc. The optical disc drive 100 may include a disc carriage 110 that is retractable to receive an optical disc. However, in lieu of a disc carriage 110, the optical disc drive 100 may include a slot in which an optical disc may be inserted directly into the optical disc drive 100. An optical pickup 120 is provided to read the tracks off of the optical disc utilizing a light beam, such as a laser. A disc driver 150 engages the optical disc, typically via a central hole provided in most optical disc media (e.g., CDs, DVDs, laser discs, etc.), and the disc driver motor 160 powers the disc driver 150 to spin the optical disc in the optical disc drive 100. A tracking mechanism 130 is provided to move the optical pickup 120 along the radius of the optical disc to read the tracks off of the optical disc. A circuit 140, such as a read only memory (ROM), a programmable read only memory (PROM) chip, or an application specific integrated circuit (ASIC), for example, stores logic/instructions to control operation of the optical disc drive 100. In one embodiment of the present invention, the logic/instructions may be stored in the circuit 140 as firmware. Other circuits may also be included in the optical disc drive 100 as well to provide control and operation of the optical disc drive 100.

As discussed above, the advent of copy-controlled CDs, e.g., Sony's key2audio™ and Sunncomm's MediaCloq™, for example, utilize various methods to keep PC-based optical disc drives from playing back audio data, or transmitting audio data digitally through an interface. Sony's key2audio™, for example, utilizes a multi-session CD having three sessions, in which the audio tracks are stored on a first session of the CD, and the Lead-Out data in the second and third sessions point to invalid addresses, thus creating an inability of a PC-based optical disc drive to access the CD due to the invalid addresses read off of the CD. Sunncomm's MediaCloq™, for example, sets a control bit as “high” (e.g., set to “1”) in the Lead-In area of the CD (e.g., Format 0000b: Track Number Data for Read TOC/PMA/ATIP Data) so that a PC-based optical disc drive recognizes the CD as having only data tracks, irrespective of whether the CD has audio tracks.

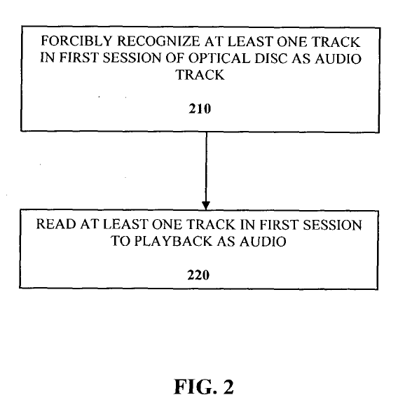

FIG. 2 illustrates a flow chart diagram of playing a copy-controlled audio disc in a PC-based optical disc drive according to an embodiment of the present invention. Both Sony's key2audio™ and Sunncomm's MediaCloq™ “trick” the PC-based optical disc drive into determining that the CD is invalid and contains no tracks, or contains no audio tracks. However, conventional dedicated CD players, for example, do not suffer from the effects of the copy protection because conventional dedicated CD players do not read multi-session discs and do not read non-audio data for playback. Accordingly, by providing logic/instructions to a PC-based optical disc drive to “mimic” the basic operation of a conventional standalone CD player, the effects of the copy protection are overcome. Logic/instructions to control and operate the optical disc drive 100 may be provided in, for example, the circuit 140 ROM/PROM, such as firmware. However, the logic/instructions may be implemented in any other suitable program code storage device, such as a circuit within the optical disc drive 100 (e.g., the CPU, ROM, etc.), or in a host system via a software program stored on a hard disk drive, or any other storage medium on the host system.

Referring to FIG. 2, in order to overcome the copy protection placed on a CCCD and to mimic a conventional standalone CD player, the PC-based optical disc drive 100 forcibly recognizes 210 at least one track in the first session of an optical disc placed into the optical disc drive 100 as an audio track. The at least one track in the first session of the optical disc is read 220 and played back by the optical disc drive 100 as audio. In this manner, the PC-based optical disc drive 100 behaves like a conventional dedicated CD player when an audio CD is placed into the optical disc drive 100, and the copy protection is ignored, just as would be the case in a conventional dedicated CD player.

According to an embodiment of the present invention, the optical disc drive 100 only overcomes the copy protection and forcibly recognizes all tracks as audio tracks on a CD and reads at least one of the tracks to playback as audio after it receives an identification/playback command from a host system, such as a home entertainment system. In this manner, the optical disc drive 100 operates to legitimately playback audio from CCCDs when demanded by the end user of the home entertainment system and is not utilized to illegally copy or “rip” tracks off of the CCCD by circumventing the copy protection.

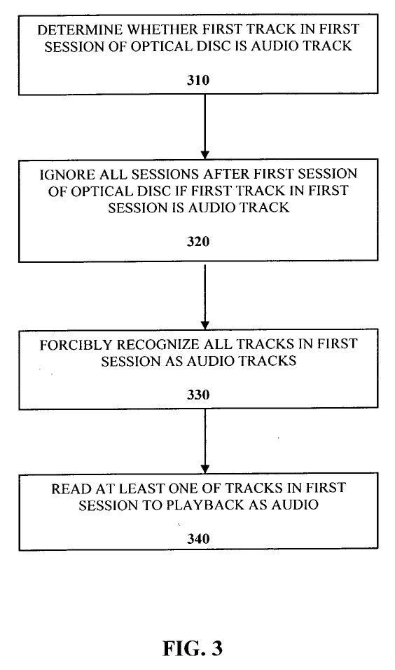

FIG. 3 illustrates a flow chart diagram of playing a copy-controlled audio disc in a PC-based optical disc drive according to an embodiment of the present invention. As mentioned above, Sony's key2audio™ utilizes a multi-session CD having three sessions, in which the audio tracks are stored on a first session of the CD, and the Lead-Out data in the second and third sessions point to invalid addresses, thus creating an inability of a PC-based optical disc drive to access the CD due to the invalid addresses read off of the CD. Referring to FIG. 3, in order to overcome a copy protection scheme such as key2audio™, for example, the PC-based optical disc drive 100 determines 310 whether the first track in the first session of an optical disc placed into the optical disc drive 100 is an audio track (e.g., the optical disc drive 100 reads the table of contents (TOC) from the lead-in area of the first session of the disc and checks the control bit to determine if the track is an audio track or a data track). If it is determined 310 that the first track in the first session of the optical disc is an audio track, then all sessions (e.g., the second and third sessions of a key2audio™ CD containing the invalid/non-format data) after the first session of the optical disc are ignored 320. By ignoring all the sessions after the first session of an optical disc, the PC-based optical disc drive 100 does not encounter the invalid or non-format Lead-Out data stored in, for example, the second and third sessions of a key2audio CD, and the CD will not be recognized as invalid but recognized as a normal CD.

The optical disc drive 100 forcibly recognizes 320 all tracks in the first session of the optical disc as audio tracks. At least one of the tracks in the first session of the optical disc is read 330 and played back by the optical disc drive 100 as audio. In this manner, the PC-based optical disc drive 100 according to an embodiment of the present invention behaves like a conventional dedicated CD player when an CCCD such as a key2audio™ CD is placed into the optical disc drive 100, and the copy protection, mainly the invalid/non-format data in the sessions following the first session, is ignored, just as would be the case in a conventional dedicated CD player, which does not have the ability to read multi-session CDs. Therefore, any sessions following the first session that contains the invalid/non-format data are not encountered or read.

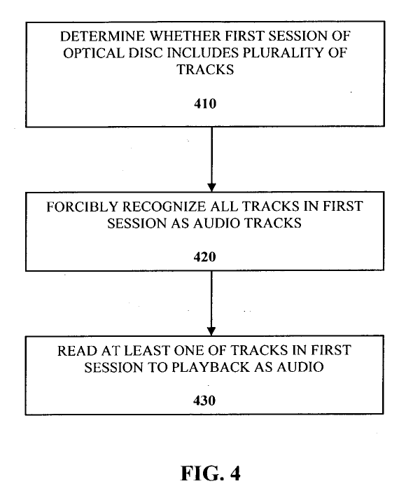

FIG. 4 illustrates a flow chart diagram of playing a copy-controlled audio disc in a PC-based optical disc drive according to an embodiment of the present invention. As mentioned above, Sunncomm's MediaCloq™ sets a control bit as “high” in the Lead-In area of the CD so that a PC-based optical disc drive recognizes the CD as having only data tracks, regardless of whether the CD has audio tracks, thus creating an inability of a PC-based optical disc drive 100 to access an audio CD because all tracks are recognized as data tracks and no audio tracks can be found. Referring to FIG. 4, in order to overcome a copy protection scheme such as MediaCloq™, for example, the PC-based optical disc drive 100 determines 410 whether the first session of an optical disc placed into the optical disc drive 100 includes a plurality of tracks. The assumption is that an overwhelming majority of audio CDs in the market place contain more than one audio track on the CD, and if there is a plurality of tracks detected in the first session of the CD, then it is very likely that the end user placed an audio CD into the PC-based optical disc drive 100, as compared to a data CD because the end user would not typically place a data CD for playback in a home entertainment system, and the optical disc drive 100 will treat the CD as an audio CD.

Accordingly, the optical disc drive 100 forcibly recognizes 420 all of the tracks in the first session of the optical disc as audio tracks if the first session includes a plurality of tracks. Once the optical disc drive 100 recognizes the tracks in the first session of the optical disc as audio tracks, it reads 430 at least one of the tracks in the first session of the optical disc for playback as audio. In this manner, the PC-based optical disc drive 100 according to an embodiment of the present invention behaves like a conventional dedicated CD player when a CCCD such as a MediaCloq™ CD is placed into the optical disc drive 100. The copy protection, mainly the control bit being set “high” in the Lead-In area of the CD so that a PC-based optical disc drive recognizes the CD as having only data tracks, is overridden and all of the tracks on the CD are treated as audio tracks, just as would be the case in a conventional dedicated CD player. The conventional dedicated CD player is unable to recognize the significance of the control bit being set “high” in the Lead-In area of the CD and it cannot read past the first session in a multi-session CD, and therefore all the tracks on a CD read by a conventional dedicated CD player are treated as audio.

In an embodiment of the present invention, the logic/instructions of FIGS. 3 and 4 may be incorporated together into an optical disc drive 100 (e.g., as firmware in the circuit 140) such that the optical disc drive 100 is capable of playing audio tracks off of multiple formats of CCCDs, such as both of key2audio™ and MediaCloq™ CDs.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A method of playing an optical disc, comprising:
forcibly recognizing at least one track in a first session of the optical disc as an audio track; and
reading the at least one track in the first session to playback as audio.

2. The method according to claim 1, wherein the optical disc is a multi-session optical disc.

3. The method according to claim 2, wherein the optical disc has three sessions.

4. The method according to claim 1, wherein a control bit in a lead-in area of the optical disc is set high to render all tracks on the optical disc to be recognized as data tracks irrespective of whether the optical disc contains audio tracks.

5. The method according to claim 1, further including receiving an identification command prior to reading the at least one track in the first session.

6. The method according to claim 1, wherein the optical disc is a compact disc (CD).

7. A method of playing an optical disc, comprising:
determining whether a first track in a first session of the optical disc is an audio track;
ignoring all sessions after the first session of the optical disc if the first track in the first session is an audio track;
forcibly recognizing all tracks in the first session as audio tracks; and
reading at least one of the tracks in the first session to playback as audio.

8. The method according to claim 7, wherein the optical disc is a multi-session optical disc.

9. The method according to claim 8, wherein the optical disc has three sessions.

10. The method according to claim 7, further including receiving an identification command prior to reading at least one of the tracks in the first session.

11. The method according to claim 7, wherein the optical disc is a compact disc (CD).

12. The method according to claim 7, wherein the optical disc is a key2audio™ compact disc (CD).

13. A method of playing an optical disc, comprising:
determining whether a first session of the optical disc includes a plurality of tracks;
forcibly recognizing all the tracks in the first session as audio tracks if the first session includes a plurality of tracks; and
reading at least one of the tracks in the first session to playback as audio.

14. The method according to claim 13, wherein a control bit in a lead-in area of the optical disc is set high to render all tracks on the optical disc to be recognized as data tracks irrespective of whether the optical disc contains audio tracks.

15. The method according to claim 13, further including receiving an identification command prior to reading the at least one of the tracks in the first session.

16. The method according to claim 13, wherein the optical disc is a multi-session optical disc.

17. The method according to claim 13, wherein the optical disc is a compact disc (CD).

18. The method according to claim 13, wherein the optical disc is a MediaCloq™ compact disc (CD).

19. A program code storage device, comprising:
a machine-readable storage medium; and
machine-readable program code, stored on the machine-readable storage medium, having logic/instructions to
forcibly recognize at least one track in a first session of an optical disc as an audio track, and
read the at least one track in the first session to playback as audio.

20. The program code storage device according to claim 19, wherein the optical disc is a multi-session optical disc.

21. The program code storage device according to claim 20, wherein the optical disc has three sessions.

22. The program code storage device according to claim 19, wherein a control bit in a lead-in area of the optical disc is set high to render all tracks on the optical disc to be recognized as data tracks irrespective of whether the optical disc contains audio tracks.

23. The program code storage device according to claim 19, wherein the machine-readable program code further includes logic/instructions to receive an identification command prior to reading the at least one track in the first session.

24. The program code storage device according to claim 19, wherein the optical disc is a compact disc (CD).

25. The program code storage device according to claim 19, wherein the program code storage device is a read only memory (ROM) chip.

26. The program code storage device according to claim 19, wherein the program code storage device is a programmable read only memory (PROM) chip.

27. A program code storage device, comprising:
a machine-readable storage medium; and
machine-readable program code, stored on the machine-readable storage medium, having logic/instructions to
determine whether a first track in a first session of an optical disc is an audio track,
ignore all sessions after the first session of the optical disc if the first track in the first session is an audio track,
forcibly recognize all tracks in the first session as audio tracks, and
read at least one of the tracks in the first session to playback as audio.

28. The program code storage device according to claim 27, wherein the optical disc is a multi-session optical disc.

29. The program code storage device according to claim 28, wherein the optical disc has three sessions.

30. The program code storage device according to claim 27, wherein the machine-readable program code further includes logic/instructions to receive an identification command prior to reading at least one of the tracks in the first session.

31. The program code storage device according to claim 27, wherein the optical disc is a compact disc (CD).

32. The program code storage device according to claim 27, wherein the optical disc is a key2audio™ compact disc (CD).

33. The program code storage device according to claim 27, wherein the program code storage device is a read only memory (ROM) chip.

34. The program code storage device according to claim 27, wherein the program code storage device is a programmable read only memory (PROM) chip.

35. A program code storage device, comprising:
a machine-readable storage medium; and
machine readable program code, stored on the machine-readable storage medium, having logic/instructions to
determine whether a first session of an optical disc includes a plurality of tracks,
forcibly recognize all the tracks in the first session as audio tracks if the first session includes a plurality of tracks, and
read at least one of the tracks in the first session to playback as audio.

36. The program code storage device according to claim 35, wherein a control bit in a lead-in area of the optical disc is set high to render all tracks on the optical disc to be recognized as data tracks irrespective of whether the optical disc contains audio tracks.

37. The program code storage device according to claim 35, wherein the machine-readable program code further includes logic/instructions to receive an identification command prior to reading the at least one of the tracks in the first session.

38. The program code storage device according to claim 35, wherein the optical disc is a multi-session optical disc.

39. The program code storage device according to claim 35, wherein the optical disc is a compact disc (CD).

40. The program code storage device according to claim 35, wherein the optical disc is a MediaCloq™ compact disc (CD).

41. The program code storage device according to claim 35, wherein the program code storage device is a read only memory (ROM) chip.

42. The program code storage device according to claim 35, wherein the program code storage device is a programmable read only memory (PROM) chip.

43. An optical disc drive, comprising:
a drive motor to spin an optical disc;
an optical pickup to read tracks off of the optical disc utilizing a light beam;
a tracking mechanism to move the optical pickup to read tracks off of the optical disc; and
a circuit that forcibly recognizes at least one track in a first session of the optical disc as an audio track, and reads the at least one track in the first session to playback as audio.

44. The optical disc drive according to claim 43, further including a disc carriage to receive the optical disc.

45. The optical disc drive according to claim 43, wherein the circuit includes firmware.

46. The optical disc drive according to claim 43, wherein the optical disc is a multi-session optical disc.

47. The optical disc drive according to claim 46, wherein the optical disc has three sessions.

48. The optical disc drive according to claim 43, wherein a control bit in a lead-in area of the optical disc is set high to render all tracks on the optical disc to be recognized as data tracks irrespective of whether the optical disc contains audio tracks.

49. The optical disc drive according to claim 43, wherein the circuit receives an identification command prior to reading the at least one track in the first session.

50. The optical disc drive according to claim 43, wherein the optical disc is a compact disc (CD).

51. The optical disc drive according to claim 43, wherein the optical disc drive is a digital versatile disc (DVD) drive.

52. An optical disc drive, comprising:
a drive motor to spin an optical disc;
an optical pickup to read tracks off of the optical disc utilizing a light beam;
a tracking mechanism to move the optical pickup to read tracks off of the optical disc; and
a circuit that determines whether a first track in a first session of the optical disc is an audio track, ignores all sessions after the first session of the optical disc if the first track in the first session is an audio track, forcibly recognizes all tracks in the first session as audio tracks, and reads at least one of the tracks in the first session to playback as audio.

53. The optical disc drive according to claim 52, further including a disc carriage to receive the optical disc.

54. The optical disc drive according to claim 52, wherein the circuit includes firmware.

55. The optical disc drive according to claim 52, wherein the optical disc is a multi-session optical disc.

56. The optical disc drive according to claim 55, wherein the optical disc has three sessions.

57. The optical disc drive according to claim 52, wherein the circuit receives an identification command prior to reading at least one of the tracks in the first session.

58. The optical disc drive according to claim 52, wherein the optical disc is a compact disc (CD).

59. The optical disc drive according to claim 52, wherein the optical disc is a key2audio™ compact disc (CD).

60. The optical disc drive according to claim 52, wherein the optical disc drive is a digital versatile disc (DVD) drive.

61. An optical disc drive, comprising:
a drive motor to spin an optical disc;
an optical pickup to read tracks off of the optical disc utilizing a light beam;
a tracking mechanism to move the optical pickup to read tracks off of the optical disc; and
a circuit that determines whether a first session of the optical disc includes a plurality of tracks, forcibly recognizes all the tracks in the first session as audio tracks if the first session includes a plurality of tracks, and reads at least one of the tracks in the first session to playback as audio.

62. The optical disc drive according to claim 61, further including a disc carriage to receive the optical disc.

63. The optical disc drive according to claim 61, wherein the circuit includes firmware.

64. The optical disc drive according to claim 61, wherein a control bit in a lead-in area of the optical disc is set high to render all tracks on the optical disc to be recognized as data tracks irrespective of whether the optical disc contains audio tracks.

65. The optical disc drive according to claim 61, wherein the circuit receives an identification command prior to reading the at least one of the tracks in the first session.

66. The optical disc drive according to claim 61, wherein the optical disc is a multi-session optical disc.

67. The optical disc drive according to claim 61, wherein the optical disc is a compact disc (CD).

68. The optical disc drive according to claim 61, wherein the optical disc is a MediaCloq™ compact disc (CD).

69. The optical disc drive according to claim 61, wherein the optical disc drive is a digital versatile disc (DVD) drive.
